(19) United States
(12) Patent Application Publication
(10) Pub. No.: US 2022/0008852 A1
(43) Pub. Date: Jan. 13, 2022

(54) METHODS IN FORMING TEMPERATURE RESISTANT INORGANIC NANO-SCALE MEMBRANE LAYER FOR IMPROVED HIGH TEMPERATURE FILTRATION

(71) Applicant: Regents of the University of Minnesota, Minneapolis, MN (US)

(72) Inventors: David You-Hong Pui, Medina, MN (US); Qisheng Ou, Vadnais Heights, MN (US)

(73) Assignee: Regents of the University of Minnesota, Minneapolis, MN (US)

(21) Appl. No.: 17/364,832

(22) Filed: Jun. 30, 2021

Related U.S. Application Data
(60) Provisional application No. 63/190,323, filed on May 19, 2021.
(60) Provisional application No. 63/049,778, filed on Jul. 9, 2020.

(51) Int. Cl. B01D 46/00; C04B 38/00; C04B 41/00; C04B 41/50; C04B 41/45; C04B 41/87

(52) U.S. Cl. CPC B01D 46/0001; C04B 38/0054; C04B 41/009; C04B 41/5035; F01N 3/2825; C04B 41/4511; C04B 41/0072; C04B 41/87; B01D 2279/30; C04B 41/4582

(57) ABSTRACT

Aspects of the disclosure provide methods of making a coated filtration material. Various methods include providing a base filter material and applying a first coating to the base filter material, the first coating being in nanoparticle form. A second coating is applied on top of the first coating, the second coating being a nanoscale inorganic material. The method further includes removing the first coating in such a way that the second coating remains on the base filter material. Methods of the disclosure can be used to manufacture coated filtration materials having a coating with a porosity of 90% or greater and a pore size in the range of 0.1-0.5 μm.

### RELATED APPLICATIONS

This Non-Provisional patent application claims the benefit of the filing dates of U.S. Provisional Patent Application Ser. No. 63/190,323, filed May 19, 2021, entitled “METHODS IN FORMING TEMPERATURE RESISTANT INORGANIC NANO-SCALE MEMBRANE LAYER FOR IMPROVED HIGH TEMPERATURE FILTRATION,” and U.S. Provisional Patent Application Ser. No. 63/049,778, filed Jul. 9, 2020, entitled “METHODS IN FORMING TEMPERATURE RESISTANT INORGANIC NANO-SCALE MEMBRANE LAYER FOR IMPROVED HIGH TEMPERATURE FILTRATION,” the entire teachings of which are incorporated herein by reference.

### BACKGROUND

Conventional ceramic wall-flow substrates are widely used in vehicle engine after-treatment applications to remove particulate matters as often regulated by emission standards. Such filters are generally known as a “Diesel Particular Filter” (DPF) or a “Gasoline Particular Filter” (GPF). Increasingly stringent emission regulations world-wide typically require DPFs/GPFs to be more efficient, which is often associated with an undesired backpressure increase, and in turn affects vehicle fuel economy and power output adversely. Moreover, when a bare ceramic material of the filter is coated with catalysts (to simultaneously remove gaseous pollutants from the engine), its filtration behavior is largely deteriorated due to the unfavorable change of micro-pore structure.

The present disclosure addresses problems and limitations associated with the related art.

### SUMMARY

Generally, aspects of the present disclosure provide a filtration material that can sustain engine exhaust temperature while offering better efficiency-backpressure tradeoff than current available wall-flow substrate. Methods of the disclosure maintain the macroscopic wall-flow configuration of conventional filters, which is believed to be the best design to provide superb filtration area in unit filter volume. At the same time, a membrane or coating added on a top or outer surface of a base filter material significantly enhances the filtration at a microscopic level.

One aspect of the disclosure provides a method of making a coated filtration material. The method includes providing a base filter material, applying a first coating to the base filter material, the first coating being in nanoparticle form and then applying a second coating on top of the first coating, the second coating being a nanoscale inorganic material. The method further includes removing the first coating in such a way that the second coating remains on the base filter material. Various methods of the disclosure ensure complete coverage of the second coating on top of the base filter material and no penetration of the second coating into pores underneath. This optimized membrane deposition pattern, and the pore structure of the base filter material, work together to give coated filtration materials of the disclosure much improved performance.

Another aspect of the disclosure provides a coated filtration material including a base filter material having an outer surface and a plurality of pores extending from the outer surface and having a depth. The coated filtration material further includes a coating, the coating being a nanoscale inorganic material positioned on the outer surface. The volume of the pores are free from the coating. In various embodiments, the coated filtration material has a porosity of at least 95% and a pore size in the range of 0.1-0.5 μm. The small pore size greatly enhances its filtration to nanoparticles, for example soot from engine exhaust. The small pore size also tends to introduce more flow resistance, which is generally undesired. This is mitigated by its much higher porosity, which provides significantly better tradeoff between efficiency and flow resistance. Also, the second coating is so efficient that a very thin layer (e.g., <20-30 μm) is sufficient for desired efficiency level in most applications, in which way its flow resistance is further reduced owning to its much thinner thickness than conventional base filter materials (which can be 200-500 μm thick, for example).

### BRIEF DESCRIPTION OF THE DRAWINGS

FIG. 1A is a schematic illustration of a coated filtration material at an intermediate stage of manufacture having a first coating and a second coating, wherein the first coating is configured to be removed.

FIG. 1B is an image of the coated filtration material of FIG. 1A after the first coating is removed.

FIG. 2 is a flow chart illustrating one method of the disclosure.

FIG. 3 is an experimental setup of soot particle generation and filter efficiency measurement.

FIG. 4A is a graph illustrating penetration of a GPF filter samples before coating and after coating with a method of the disclosure, such as that outlined in FIG. 2.

FIG. 4B is a graph illustrating Figure of Merit of the GPF filter samples of FIG. 4A, before coating and after coating with a method of the disclosure, such as that outlined in FIG. 2.

### DETAILED DESCRIPTION

Generally, aspects of the present disclosure provide a coated filtration material that can sustain high temperature (e.g., engine exhaust) while offering better efficiency-backpressure tradeoff than current available wall-flow substrates. Methods of the disclosure maintain the macroscopic wall-flow configuration of a base filter material, which is believed to be one preferred design to provide superb filtration area in unit filter volume. At the same time, a coating added on the upstream or outer surface of the base filter material significantly enhances the filtration of the coated filtration material at a microscopic level.

Techniques of the disclosure can be applied to improve filter performance in almost every high-temperature filtration application. Specifically, for vehicle after-treatment applications such as Diesel Particulate filters or Gasoline Particulate Filters, nano-scale membrane coated filters can be adopted using the present techniques to dramatically improve both initial filtration efficiency and soot loading behavior of existing Diesel Particulate filters or Gasoline Particulate Filters. The aspects of the disclosure are believed to be particularly beneficial for catalyst-coated Diesel Particulate filters or Gasoline Particulate Filters as the present methods can overcome the downside of conventional Diesel Particulate filters or Gasoline Particulate Filters, which tend to further lose their already mediocre efficiency after being catalyst-coated.

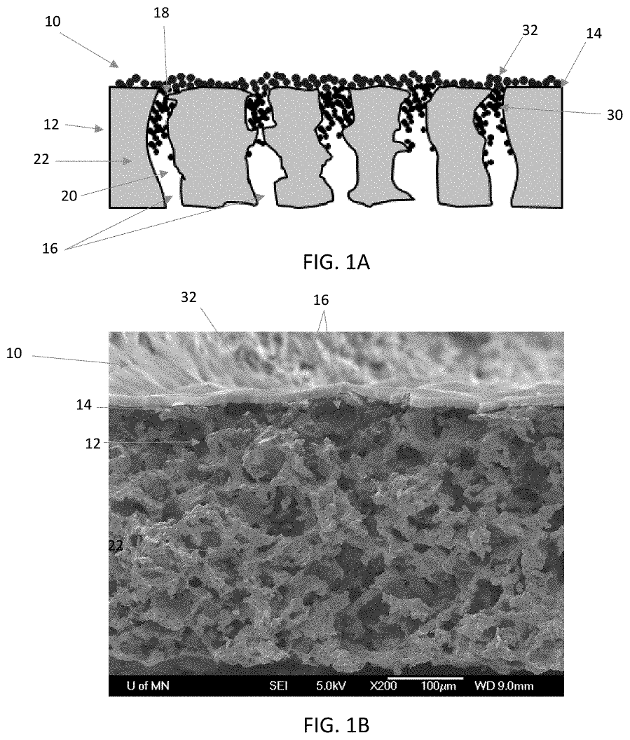

One example of a coated filtration material 10 of the disclosure during an intermediate stage of manufacture is illustrated schematically in FIG. 1A. The coated filtration material 10 includes a base filter material 12 having an outer or upstream surface 14 and defining a plurality of pores 16 (generally referenced). At least some of the pores 16 have an opening 18 at the outer surface 14 and a depth or volume 20 extending into a core 22 of the base filter material 12 (only one such representative pore 16 is fully labeled for ease of illustration). The base filter material 12 be any granular based filtration material for high temperature gas filtration. In various embodiments, the base filter material can be any porous granular filter media made of metal, ceramic, or other materials that can substance a high temperature filtration environment. For example, the base filtration material 12 can include sintered ceramic powder media or sintered metal powder media. These materials are particularly useful base filter materials 12 for applications in engine emission control, other hot gas filtrations, including but not limited to, flue gas filtration from coal-fired power plants (pressurized fluid-bed combustion integrated gasification combined-cycle), high temperature and pressure filtration in petrochemical industrial, and biomass burning exhaust filtration. These materials may have a porosity in a range of 30-70% and a mean pore size between 1-100 μm. In one example, the base filter material 12 has a thickness in the range of 200-500 μm.

At the illustrated intermediate stage of FIG. 1A, the coated filtration material 10 further includes a first coating 30 (generally referenced) including a first, nanoscale material and a second coating or membrane 32 (generally referenced) including a nanoscale inorganic material, such as a metal oxide, disposed over the first coating 30. The second coating 32 can include a metal oxide, such as silicon dioxide and/or aluminum oxide, for example. In essence, the first coating 30 at least partially fills the pores 16 at the outer surface 14 and blocks the respective pore openings 18 so that during application of the second coating 32, the second coating 32 cannot enter the depth 20 of or occupy any of the pores 16. In various embodiments, the second coating 32 has a pore size in the range of 0.1-0.5 μm and in some embodiments the pore size is in the range of 0.1-0.2 μm. In some embodiments, the second coating 32 has a porosity of at least 90% and in some embodiments the porosity is at least 95%. In some embodiments, the second coating 32 has a thickness of less than 50 μm and in some embodiments the thickness is less than 30 μm. In various embodiments, the second coating 32 has a particle size in the range of 20-200 nm and in some embodiments the second coating 32 has particle size in the range of 20-50 nm. In one embodiment, the thickness of the second coating 32 is less than 20 μm. The first coating 30 is configured to be cleanable, removable from the base filter material 12 after the second coating 32 is applied to result in the final coated filtration material 10 of FIG. 1B. After removal of the first coating 30, the second coating 32 is positioned on the outer surface 14 of the base filter material 12 as shown in FIG. 1B. Therefore, the resultant coated filtration material 10 is manufactured such that the volume 20 of the pores 16 of the base filter material 12 are free from the second coating 32. In other words, the second coating 32 covers the openings 20 of the pores 16 but does not extend past the pore openings 18, into the depth 18 of the pores 16 toward the core 22, past the outer surface 14. Additional details regarding the coated filtration material 10 and its components are discussed below with respect to how coated filtration materials of the disclosure can be manufactured.

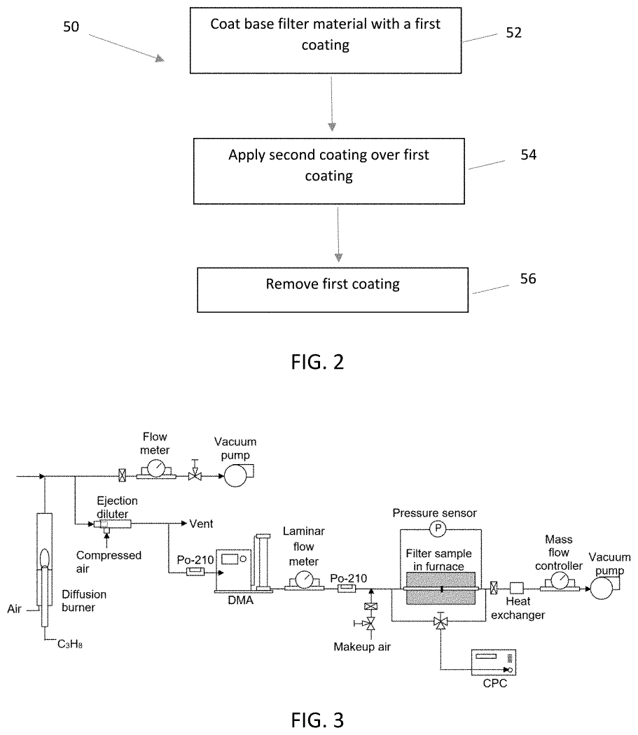

Referring now in addition to FIG. 2, in one method 50 of the disclosure, the method 50 includes a first coating step 52 including applying a first coating of a first material including removable nanoparticles to fill substantially all (i.e. 99% or more) the micro-structured pores in a base filter material, which can be any of the type disclosed above. In one example, 100% of the openings (of pores including pore openings) of the base filter material are at least 98% blocked (i.e. obstructed) by the first coating. The method further includes a second coating step 54 including applying a second material including targeted membrane materials (e.g., any nanoscale inorganic materials that can sustain high temperature of at least 300° C.) on top of the first coating to form a double coated material (see also, FIG. 1A). The steps of applying can be conducted via an aerosol dispersion, for example. Subsequently, the double coated material undergoes thermal or chemical treatment to remove the first coating so that only the second coating remains on the base filer material 56.

In other examples, the first material of the first coating 30 can include nanoparticles made of hygroscopic salt, which can be removed later by dissolving in deionized water. As the preliminary step in methods of the disclosure is to occupy substantially all available micro-pores in the base filter material with the nanoparticles, the nanoparticles can be any of a variety of materials provided in nanoparticle form that can sustain high temperature (i.e. a temperature for their intended application) such as silica, alumina, carbon soot or the like, for example.

The aforementioned methods form a coated filtration material, which includes a highly porous (porosity of at least 95%) second coating on top of the base filter material (in some embodiments having a porosity of about 30% to about 70% and in other embodiments the porosity is in the range of about 40% to about 65%), with much smaller pore size in nanoscale, which significantly improves the filtration performance of the coated filtration material. The initial filtration efficiency can be enhanced by more than one order of magnitude, with only a small amount of backpressure penalty. The second coating on the base filter material also largely extends the useful lifetime of the base filter material (without the second coating as applied by methods of the disclosure) between each regeneration cycle in engine emission applications.

### Example 1

In one example, the first coating includes soot nanoparticles. Soot nanoparticles can be easily generated from a combustion process (e.g., a simple diffusion flame). After deposition on a ceramic base filter material, the soot nanoparticles can be removed by thermally heating the coated filter to 500-650° C. under an air environment (or nitrogen with only trace amount of oxygen). This example method is beneficial for ceramic a base filter material where material oxidation is not a concern.

### Example 2

In another example, the first coating includes soot nanoparticles. Soot nanoparticles can be easily generated from a combustion process (e.g., a simple diffusion flame). After deposition on a metallic base filter material, the soot nanoparticles can be removed by thermally heating the coated filter to a temperature between 500-650° C. under a nitrogen environment with only trace amount of oxygen to prevent oxidation of the metallic base filter.

### Example 3

In yet another example, the first coating includes water-soluble salts in nanoparticle form. Water-soluble salts in nanoparticle from can be easily generated from aqueous salt solutions by a mechanical atomizer. Examples of salt materials can include, but are not limited to sodium chloride or potassium chloride. After deposition on the base filter material, the first coating can be removed by simply soaking and gently washing the coated base material under deionized water. This method is beneficial when the base filter material is metallic and/or when metal oxidation needs to be eliminated.

Demonstration:

In this particular demonstration, one typical wall-flow ceramic core sample is chosen as the base filter material. The base filter material is made of cordierite, with a cell density of 300 cpsi (cells per square inch) and a wall thickness of 12 mil (305 μm). The base filter material is 1″ in diameter and 6″ in length. A ceramic wall or outer surface in the base filter material has a porosity of 60% with a mean pore size of −15 μm. This base filter material sample is a representative example of state-of-art filter materials for gasoline particulate filter (GPF) applications, which is used to remove nanometer scale soot particles from gasoline direct injection (GDI) engine exhaust.

After the filtration efficiency of the uncoated or bare base filter material sample being evaluated (with detailed descriptions below), this sample was then coated as generally shown and discussed with respect to FIG. 2. In particular, soot particles served as the first coating to occupy all pores in the base filter material, followed by a second coating being silica membrane material, followed by removal of the first coating via a thermal treatment to remove soot particles and improve silica adhesion by calcinating the coated base material under 900° C. for 60 min. The filtration efficiency of the coated filtration material was then evaluated for a second time.

FIG. 3 shows a schematic of the experimental apparatus used for particle generation and filter performance evaluation. A propane diffusion flame burner is used to generate soot particles with similar morphologies to those in GDI engine exhaust. Soot particles are then diluted by a two-stage injection dilutor to further reduce their concentration to the level suitable for aerosol instruments.

A small portion (typically 1.0 liter per minute) of this diluted soot-laden aerosol flow is then introduced into a Differential Mobility Analyzer (DMA, TSI Inc., Model 3081) and only particles with mobility in a narrow range exit. These nearly mono-dispersed soot particles represent the challenge aerosols for the filter media initial collection efficiency measurements. Their concentrations are maintained to be less than 10000 #/cc to avoid any loading effect on the measurements. A Condensation Particle Counter (CPC, TSI Inc., Model 3775) was used to measure the soot particle number concentrations both upstream and downstream of the filter sample. The collection efficiency (E) of each particle size is determined by taking the ratio of downstream-to-upstream reading, after correcting for particle loss as measured in a blank test; thus,

$$E = 1 - P = 1 - \frac{{Conc}_{dn}}{{Conc}_{up}} \text{/} \frac{{Conc}_{dn , blank}}{{Conc}_{up , blank}} . \qquad [ 1 ]$$

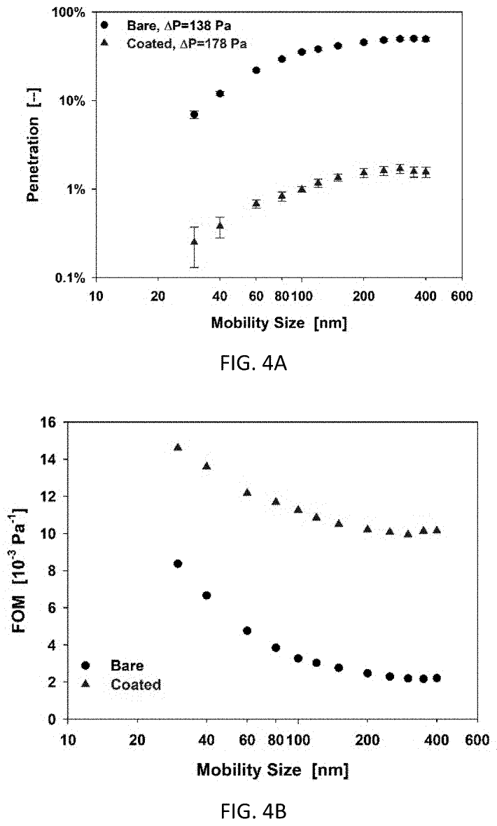

Here, P denotes the size dependent penetration of soot particles, Concᵤₚ and Conc_{dn} are the upstream and downstream particle number concentrations, and Conc_{up,blank} and Conc_{dn,blank} are the upstream and downstream particle number concentrations for the blank test. The latter is conducted under the same test condition as the efficiency measurement, but with no filter media in the filter holder; its purpose is to account for particle losses in the test system, which mostly comes from diffusion and thermophoresis of soot particles. The filter sample is evaluated at a space velocity of 17.5K and under 23° C.

[29] As shown in FIG. 4A, the uncoated, bare filter core sample has efficiency of 64.7% and 50.3% at 100 and 300 nm respectively, and a flow resistance of 138 Pa. After being coated with nanoscale silica membrane using the method of the disclosure, its efficiency is largely improved to 99.0% and 98.3% at 100 and 300 nm respectively under the same testing condition. This efficiency level is sufficient for GDI engine vehicles to pass all existing emission regulations worldwide with plenty of margin. With the large improvement on efficiency, its flow resistance only increases by 30% at 178 Pa. The net effect is a much enhanced Figure of Merit (FOM), which describes the tradeoff between efficiency and resistance of a filter, with a higher value desired. As shown in FIG. 4B, the combination of the membrane material and coating method achieves the large increase of FOM by a factor of 3.5 and 4.5 at 100 and 300 nm respectively. The present inventors believe that this is the first time such degree of improvement has been reported.

Aspects of the disclosure relate to methods for the deposition of a highly porous layer into ceramic filtration materials to improve their performance. In one example, a two-step coating process is used to coat a nanoscale filtration layer.

What is claimed is:

1. A method of manufacturing a coated filtration material, the method comprising:
providing a base filter material;
applying a first coating to the base filter material, the first coating being in nanoparticle form;
applying a second coating on top of the first coating, the second coating being a nanoscale inorganic material; and
removing the first coating in such a way that the second coating remains on the base filter material.

2. The method of claim 1, wherein the step of removing includes chemically removing the first coating.

3. The method of claim 1, wherein the step of removing includes thermally removing the first coating.

4. The method of claim 1, wherein the first coating is selected from the group consisting of hygroscopic salt and carbon soot.

5. The method of claim 1, where in the second coating includes a metal oxide.

6. The method of claim 1, wherein the second coating has a porosity greater than 90%.

7. The method of claim 1, wherein the base filter material is selected from the group consisting of sintered ceramic powder media and sintered metal powder media.

8. The method of claim 1, wherein the second coating has particles size in the range of 20-200 nm.

9. The method of claim 1, wherein the base filter material has a porosity in the range of 30-70%.

10. The method of claim 1, wherein the base filter material has a pore size in the range of 1 to 110 μm.

11. The method of claim 1, wherein the second coating has a thickness of 50 μm or less.

12. A coated filtration material comprising:
a base filter material having an outer surface and a plurality of pores extending from the outer surface and having a depth; and
a coating, the coating being a nanoscale inorganic material positioned on the outer surface; wherein the volume of the pores are free from the coating and the coating has a porosity of at least 90%.

13. The coated filtration material of claim 12, wherein the base filter material has a porosity in the range of 30-70%.

14. The coated filtration material of claim 12, wherein the coating includes a metal oxide.

15. The coated filtration material of claim 12, wherein the base filter material is selected from the group consisting of sintered ceramic powder media and sintered metal powder media.

16. The coated filtration material of claim 12, wherein the second coating has particles size in the range of 20-200 nm.

17. The coated filtration material of claim 12, wherein the second coating has a thickness of 50 μm or less.

18. The coated filtration material of claim 12, wherein the base filter material has a pore size in the range of 1 to 110 μm.

19. The coated filtration material of claim 12, wherein the coating has a pore size in the range of 0.1-0.5 μm.
